(19) United States
(12) Patent Application Publication
(10) Pub. No.: US 2024/0249046 A1
(43) Pub. Date: Jul. 25, 2024

(54) COMPUTATIONAL FLUID DYNAMICS (CFD) METHOD INCLUDING A KINETICS-BASED MODEL FOR SPECIES RESPONSE IN A FLAME FRONT

(71) Applicant: ANSYS, INC., Canonsburg, PA (US)

(72) Inventors: Karthik V. Puduppakkam, San Diego, CA (US); Abhijit U. Modak, San Diego, CA (US); Chitralkumar V. Naik, San Diego, CA (US); Ellen Meeks, Livermore, CA (US)

(21) Appl. No.: 18/156,676

(22) Filed: Jan. 19, 2023

(51) Int. Cl. G06F 30/28

(52) U.S. Cl. CPC G06F 30/28; G06F 2111/10

(57) ABSTRACT

Embodiments are disclosed of a computer-implemented method. The method includes establishing a computational grid that includes a plurality of computational cells and describes a volume containing a combustible fluid mixture. The method identifies positions in the computational grid of a flame front propagating through the combustible fluid mixture, identifies a set of representative computational cells that can be used as a computational representation of the flame front, and applies a well-mixed-reactor model and a G-equation model to every computational cell within the set of representative computational cells to compute chemical results from combustion of the combustible fluid mixture in the flame front.

### TECHNICAL FIELD

The disclosed embodiments relate generally to computational fluid dynamics (CFD) and in particular, but not exclusively, to a CFD method that uses a kinetics-based species response model in a flame front to accurately predict combustion and emissions.

### BACKGROUND

Combustion flows are fluid flows in which chemical reactions such as combustion are happening. An example of a combustion flow happens in spark-ignited engines such as the well-known internal combustion engine: a fuel is injected into a closed volume such as an engine cylinder and the fuel-air mixture is ignited by a spark plug, setting off a flame front that begins in the region surrounding the spark plug and propagates through the volume. Combustion happens between the leading and trailing edges of the flame front as it moves through the fuel-air mixture in the volume until it combusts as much of the fuel in the volume as possible.

Computational Fluid Dynamics (CFD) codes can be used to compute the flow characteristics of these combustion flows, including calcu-lating the chemical species that remain after combustion (e.g., soot, carbon monoxide, carbon dioxide, NOx, etc.); in an internal combustion engine, these remaining chemical species become the engine's emissions. Ever-stricter emis-sion regulations make it important to accurately predict emissions, but in CFD codes there is often a tradeoff between accuracy and computational efficiency. Accurate codes are less computationally efficient, requiring a lot of computational resources. Less-accurate codes are more computationally efficient but incorporate assumptions that can substantially reduce the code's accuracy.

### BRIEF DESCRIPTION OF THE DRAWINGS

Non-limiting and non-exhaustive embodiments of the present invention are described with reference to the following figures, in which like reference numerals refer to like parts throughout the various views unless oth-erwise specified.

FIGS. 1A-IC are diagrams of a volume with a flame front propagating through a combustible mixture. FIG. 1A shows the initial position of the flame front near an ignition source, FIG. 1B shows the flame front as it propagates through the combustible mixture, and FIG. 1C shows the volume after the flame front has finished moving through the combustible mixture.

FIG. 2 is a drawing of an embodiment of a computational grid in the interior of the volume having a flame front propagating through a combustible mixture as shown in FIGS. 1A-1C.

FIG. 3 is a close-up drawing of the computational grid and the flame front shown in the box highlighted in FIG. 2.

FIG. 4 is a block diagram of an embodiment of a Computational Fluid Dynamics code.

FIG. 5 is a flowchart of an embodiment of a process for analyz-ing a flame front such as the one shown in FIGS. 1A-IC using a computational grid such as the one in FIGS. 2-3.

FIG. 6 is a flowchart of an embodiment of a sub-process of the process shown in FIG. 5.

FIGS. 7A-7C are diagrams of embodiments of representative computational cells for applying a sub-grid well-mixed-reactor model to a flame front.

FIG. 8 is a graph comparing chemical results obtained using the well-mixed-reactor model with chemical results obtained using the equilibrium assumption.

FIG. 9 is a block diagram of an embodiment of a data processing system that can be used to implement the methods described in previous figures.

FIG. 10 is a block diagram of an embodiment of a system that can be used to implement the methods described herein.

FIGS. 11A-11C are block diagrams of embodiments of systems that can be used to implement the methods described herein.

### SUMMARY

In one aspect a non-transitory machine-readable medium stores executable instructions which, when executed by a data processing system, cause the data processing system to establish a computational grid including a plurality of computational cells that represent a volume containing a combustible fluid mixture. The instructions further identify positions in the computational grid of a flame front propagating through the combustible fluid mixture, identify, using a flame propagation model, a set of representative computational cells that contain a computational representation of the flame front; and apply a sub-grid well-mixed-reactor model to the flame-front volume inside every computational cell within the set of representative computational cells to compute chemical results from combustion of the combustible fluid mixture in the flame front.

In an embodiment the executable instructions further include instructions to compute fluid dynamic characteristics within the volume using a flow solver. In another embodiment the well-mixed reactor model is integrated with the flow solver, and in a further embodiment the G-equation model is integrated with the well-mixed reactor model. In yet another embodiment the positions of the flame front in the computational grid are identified using the G-equation model.

In an embodiment the representative computational cells are a set of computational cells all of which have any part of the flame front within them. In another embodiment the computational cells that have any part of the flame front within them include computational cells that are intersected by a leading edge of the flame front, a trailing edge of the flame front, or both the leading and trailing edges of the flame front. In still another embodiment the representative computational cells further include computational cells ahead of and not intersected by the leading edge of the flame front, computational cells behind and not intersected by the trailing edge of the flame front, or both. And in yet another embodiment the computational cells that have any part of the flame front within them include computational cells that are entirely within the flame front.

In another aspect, a computer-implemented method includes establishing a computational grid that represents a volume containing a combustible fluid mixture, the computational grid including a plurality of computational cells. The method identifies positions in the computational grid of a flame front propagating through the combustible fluid mixture, identifies, using a flame propagation model, a set of representative computational cells that contain a computational representation of the flame front, and applies a sub-grid well-mixed-reactor model to the flame-front volume inside to every computational cell within the set of representative computational cells to compute chemical results from combustion of the combustible fluid mixture in the flame front.

In an embodiment, the method further comprises computing fluid dynamic characteristics within the volume using a flow solver. In another embodiment the well-mixed-reactor model is integrated with the flow solver. In still another embodiment the G-equation model is integrated with the well-mixed-reactor model. In another embodiment the positions of the flame front in the computational grid are identified using the G-equation model.

In an embodiment the representative computational cells are a set of computational cells all of which have any part of the flame front within them. In another embodiment the computational cells that have any part of the flame front within them include computational cells that are intersected by a leading edge of the flame front, a trailing edge of the flame front, or both the leading and trailing edges of the flame front. In still another embodiment the representative computational cells further include computational cells ahead of and not intersected by the leading edge of the flame front, computational cells behind and not intersected by the trailing edge of the flame front, or both. And in yet another embodiment the computational cells that have any part of the flame front within them include computational cells that are entirely within the flame front.

### DETAILED DESCRIPTION

Embodiments are described of a system and method for computational fluid dynamics (CFD) analysis of combustible flows using a kinet-ics-based model for species response in a flame front. Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless encompassed within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the particular features, structures, or characteristics may be combined in any suitable manner in one or more embodiments.

When designing engines, usually several different configura-tions are first explored with computer simulations. It is critical to get the correct trends of emissions during such engine design exploration, but quantitative nu-merical prediction of particulate matter and unburned hydrocarbon pollutants is highly sensitive to chemical composition and temperature. Design of modern combustion engines heavily relies on computational modeling/simulation tools. A key requirement of such tools is to produce accurate quantitative pre-dictions of the amounts of particulate matter, such as soot, and other gas-phase pollutants, such as carbon monoxide and unburned hydrocarbons that result from combustion. This requirement translates into a very challenging numeri-cal problem-namely, modeling physio-chemical interactions across disparate time scales and length scales. In particular, this can involve simulation of fluid flow-field, sharp interfaces (e.g., flame fronts), detailed gas-phase chemistry, and particulate formation and destruction. Emissions of particulate matter and unburned hydrocarbons are regulated due to their deleterious effects on health and the environment.

Previous computational solutions for combustible flows use the simplifying assumption that chemical reactions—i.e., combustion-within the flow reach equilibrium within the flame front. This equilibrium assumption is useful, but it has lower-than-needed accuracy, especially with soot precursors and other emissions-related species that will not have time to reach equilibrium in the flame-front thickness. The current solution instead tracks the thin flame front using a computationally efficient G-equation combustion model and combines this efficient flame front tracking with a sub-grid well-mixed-reactor model that is used to calculate chemical species conversion and heat-release rates for each computational grid cell in a set of computational cells that contains the flame front. Use of a well-mixed-reactor model instead of the equilibrium assumption allows consideration of local conditions and chemical species residence times within the flame front and thus accounts for non-equilibrium effects, which can be significant.

The disclosed embodiments are of a simulation method that combines a CFD code with an efficient flame tracking method and a sub-grid well-mixed-reactor model applied cell-by-cell in computational grid cells that represent the flame front. The simulation method replaces the equilibrium assumption with greater consideration of the actual chemical dynamics happening within the flame front. The more specific problem solved by the disclosed embodiments, then, is of creating a CFD code for spark-ignited engines that accurately captures the chemistry while being computationally efficient.

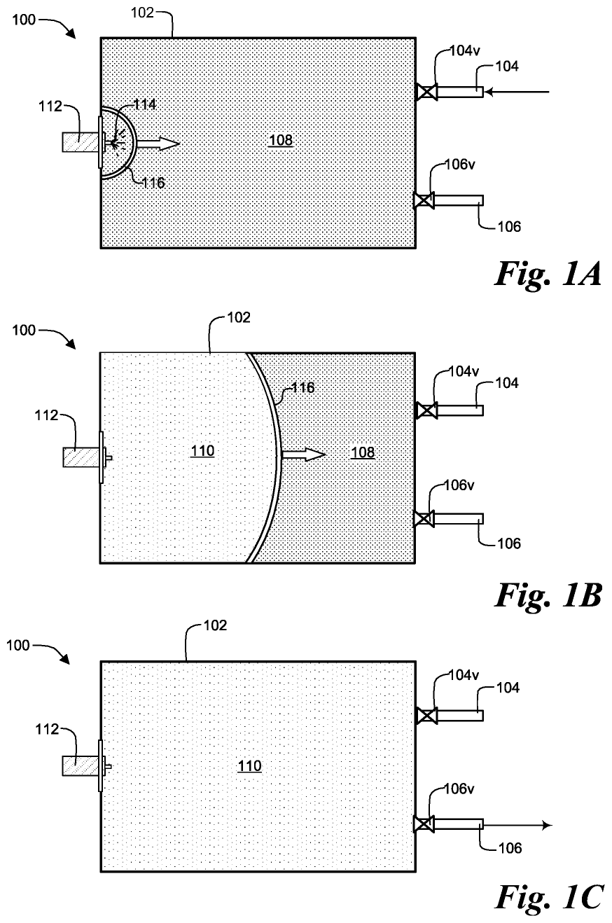

FIGS. 1A-IC together illustrate an embodiment of combustion in a spark-initiated combustion system 100. In one embodiment system 100 can be a cylinder in an internal combustion engine, but in other embodiments it can be a different system. System 100 includes a volume 102 with an inlet 104 through which a combustible mixture, such as a fuel/air mixture 108, can flow into the interior of the volume and an outlet 106 through which combustion products 110 can flow out of the volume. Inlet 104 can include an inlet valve 104v that starts, stops, or meters the flow of the fuel-air mixture 108 into volume 102. Outlet 106 can likewise include an outlet valve 106v that starts, stops, or meters the flow of combustion products 110 out of the volume. Although in the illustrated embodiment combustible mixture 108 enters volume 102 through a single inlet 104, other embodiments can include multiple inlets e.g., an inlet through which fuel enters volume 102 and another inlet through which air enters the volume. Still other embodiments can include multiple out-lets 106. Other embodiments can include fuel injection through an injector.

An igniter 112 is positioned so that it can create a spark 114 in fuel/air mixture 108 in volume 102. In one embodiment igniter 112 can be a spark plug such as the ones found in internal combustion engines, but other types of igniters can be used in other embodiments. Spark 114 ignites the fuel/air mixture, creating a flame front 116 where combustion of fuel/air mixture 108 happens.

Before the state shown in FIG. 1A, valve 104v will have been opened, combustible mixture 108 injected through inlet 104 into volume 102, and valve 104v closed after injection is complete. Valve 106v will typically stay closed throughout this part of the process. In an embodiment where volume 102 is a cylinder in an internal combustion engine, combustible mixture 108 can be a mixture of air with a hydrocarbon such as gasoline or diesel fuel, but in other embodiments other fuels and other oxidizers can be used.

FIG. 1A shows the beginning and early part of combustion.

With fuel/air mixture 108 in the volume, igniter 112 generates a spark 114, which in different embodiments can be a discrete spark, a series of discrete sparks, or a continuous spark. Spark 114 initiates combustion of fuel/air mixture 108, setting off a flame front 116 within volume 102 in the vicinity of igniter 110. Once combustion has begun, igniter 110 can be turned off so that it stops sparking.

FIG. 1B shows a later part of the combustion after flame front 116 has fully developed and is moving through the volume. After flame front 116 is created in fuel/air mixture 108 by spark 114, the flame front moves through the fuel/air mixture, as illustrated by the arrow in the figure, from the end of volume 102 where the igniter is located to the opposite end of the volume where, in this embodiment, the inlet and outlet are located. Combustion happens primarily within flame front 116, so that as the flame front moves through fuel/air mixture 108 there is fuel/air mixture 108 ahead of the flame front, combustion within the flame front, and combustion products 110 left behind the flame front. The majority of the heat release occurs in this thin flame front, and emissions start from this flame front.

FIG. 1C illustrates the state after combustion has ceased. When flame front 116 has completed its journey through volume 102, combustion products 110 are left behind in the volume. Combustion products 110 can include the various chemical compounds that result from combustion of the fuel/air mixture-carbon dioxide, carbon monoxide, other hydrocarbons, wa-ter, soot, etc. If combustion of fuel/air mixture 108 is incomplete, combustion products 110 can also include a non-zero amount of the fuel/air mixture. After the state shown in FIG. 1C, valve 106v will be opened, combustion products 110 exhausted through outlet 106, and valve 106v closed after exhaust is complete. Valve 104v will typically stay closed throughout this part of the process. A method for determining the chemical composition of combustion products 110, and hence of the exhaust that comes out of outlet 106, is described below.

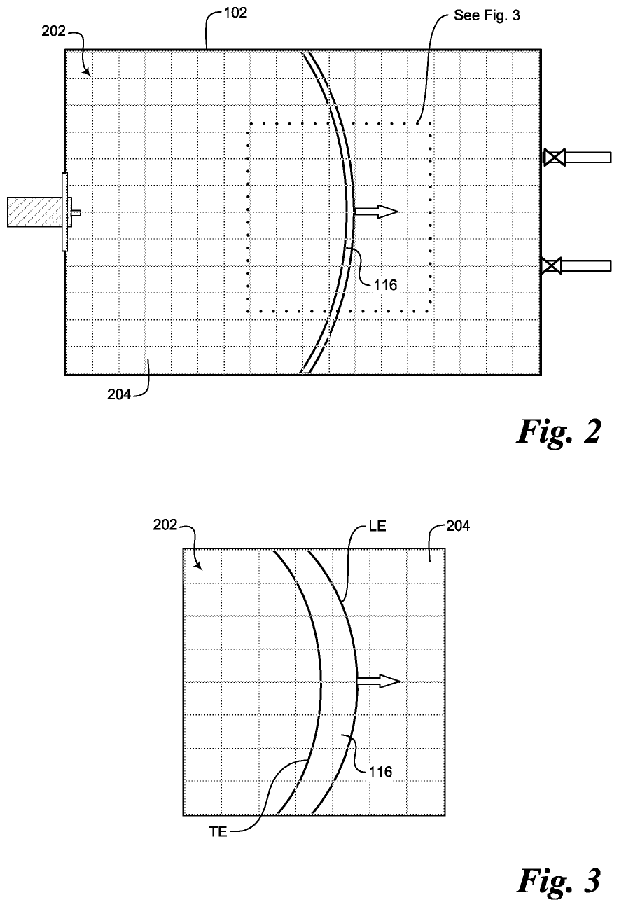

FIG. 2 illustrates an embodiment of a computational grid that can be used to model and simulate the combustion shown in FIGS. 1A-1C using a computational fluid dynamics (CFD) code. Grid 202 is not a tangible physical grid, nor a network of computers, but rather a grid that is a mathematical representation of volume 102. Mathematically, then, grid 202 conforms to the boundaries of volume 102 and occupies most or all of the volume. Grid 202 includes multiple points, each defined by a set of coordinates, and each point represents a vertex of one or more individual computational cells 204. In one embodiment the points in grid 202 can be defined in cartesian coordinates-i .e., in a cartesian (x, y, z) coordinate system—but in other embodiments the points can be defined using other coordinate systems, such as a cylindrical (r, 0, z) or spherical (r, 0. ø) coordinate system. In addition to having a spatial relationship to the volume 102 and with each other, individual cells 204 also have a logical relationship to each other, for instance as members of an array. In the illustrated embodiment cells 204 are shown as two-dimensional quadri-laterals-squares in this case. Square cells 204 can be used for two-dimensional simulations, but most real-world situations are three-dimensional, in which case the cells, although illustrated two-dimensionally in the figure, would be three-dimensional shapes such as hexahedrons. Other embodiments can use other three-dimensional polyhedral shapes, such as tetrahedrons. In the illustrated embodiment grid 202 is uniform, with all cells 204 having substantially the same size and shape, but in other embodiments the grid need not be uniform.

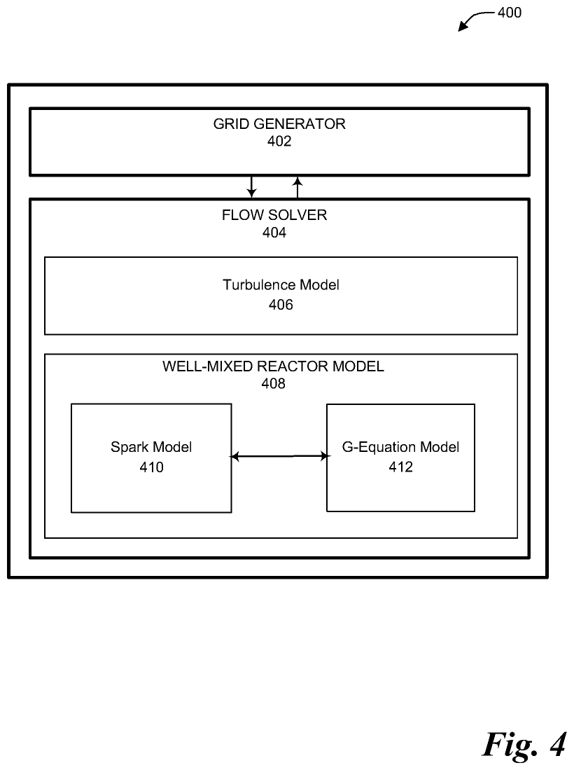

FIG. 3 is an enlargement of the rectangular area surrounding flame front 116 in FIG. 2. The figure illustrates an embodiment of the part of computational grid 200 near flame front 116. Flame front 116 has a leading edge LE and a trailing edge TE and a thickness t that is substantially the dis-tance between the leading and trailing edges. In the illustrated embodiment the flame front's thickness t is substantially constant, but in other embodiments it need not be. Flame front 116, as discussed above, moves in the direction show by the arrow. The speed of flame front 116 is generally characterized by the speed of the mean flame front, which is a line (in two dimensions) or a surface (in three dimensions) halfway between the leading edge LE and trailing edge TE of the flame front. In one embodiment the position of flame front 116 on grid 202 can be determined with a level-set model such as a G-equation combustion model, which can also be coupled with a CFD flow solver or can be a separate model or sub-model of a flow solver.

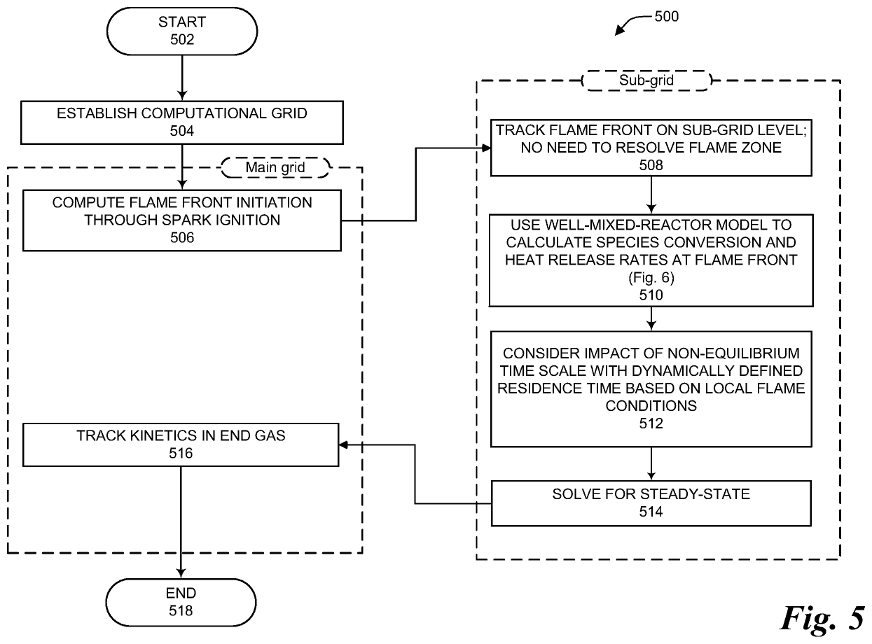

FIG. 4 illustrates an embodiment of a computational fluid dynamics (CFD) code 400 that can be used together with an embodiment of computational grid 202 to solve for flow characteristics and chemical results during combustion within volume 102.

CFD code 400 includes two main components: a grid generator 402 that generates computational grid 202 and a flow solver 404 that uses grid 202 to solve for the flow characteristics and chemical results. In the illustrated embodiment grid generator 402 is part of CFD code 400, but in other embodiments it can be a completely separate module whose results are then provided as an input to CFD code 400. In embodiments where grid generator 402 is part of CFD code 400 it can be run once to generate a computational grid 202 and thereafter have no interaction with flow solver 404. But in other embodiments grid generator 402 can interact with flow solver 404, for instance in embodiments that use adaptive grids to capture certain flow features.

Flow solver 404 can be used to simulate the fluid dynamic characteristics of fluid flow within volume 102 and can include models and sub-models that allow it to simulate chemical reactions and chemical results of combustion within the volume. Fluid dynamic characteristics of the flow can include density, pressure, temperature, and components of fluid velocity. Chemical results can include the presence and concentrations of various pre-combustion or post-combustion chemical compounds, including a mix of both pre-combustion chemical compounds (e.g., fuel, soot, other precursors of combustion) and post-combustion compounds. In one embodiment flow solver 404 can be an inviscid flow solver such as an Euler solver, but in other embodiment it can be a flow solver that accounts for the effects of viscosity, such as a Na-vier-Stokes solver.

Flow solver 404 can include various models and sub-models that allow it to simulate phenomena besides the basic fluid dynamics. In the illustrated embodiment flow solver 404 includes a turbulence model 406 and a chemically-reacting flow model 408 (i.e., a model for chemically-reacting flows). In one embodiment turbulence model 406 and chemically-reacting flow model 408 can be integrated with flow solver 404, but in other embodiments turbulence model 406, chemically-reacting flow model 408, or both, can be separate from the flow solver while still exchanging data with the flow solver and with each other.

In one embodiment turbulence model 406 can be an eddy viscosity model, but in other embodiments it can be another turbulence model, such as a Spalart-Allmaras (S-A) model, k-epsilon (k-E) model, k-omega (k-@) model, or other turbulence model. In the illustrated embodiment the chemi-cally-reacting flow model is a sub-grid well-mixed reactor model 408 that is used to simulate chemical processes in the flame front simulated by flow solver 404. Other embodiments can, of course, use different chemically-reacting flow models. The well-mixed-reactor model in general is a grid-level model, mean-ing that it resolves chemical processes that occur at length scales of substantially the same size as a computational cell. The sub-grid well-mixed reactor model described here treats the contents within the flame front as well mixed, instead of the entire computational cell contents.

Well-mixed reactor model 408 can include one or more sub-models that allow it to simulate chemical processes a sub-grid level, such as chemical reactions in flame front 116, which usually is much smaller in scale than the cells in grid 202. In the illustrated embodiment, flow model 408 includes a spark model 410 and a G-equation model 412. In one embodiment spark model 410 and G-equation model 412 can be integrated with well-mixed reactor mode 408, but in other embodiments the spark model 410, G-equation model 412, or both, can be separate from the well-mixed reactor model while still exchanging data with the well-mixed reactor model and with each other.

Spark model 410 is used for modeling the ignition (i.e., the start) and early propagation of flame front 116. In one embodiment spark model 410 can be a Discrete Particle Ignition Kernel (DPIK) spark model, which accounts for the effects of electrode heat transfer, spark energy, and chemical heat release from the fuel on the early flame kernel growth, although other embodiments can of course use a different spark-ignition model. G-equation model 412 is a sub-grid model that attempts, among other things, to estimate the turbulent flame speed based on the local conditions of fuel concentration and turbulence intensity. The G-equation model, which in addition to being a sub-grid model is an example of a level-set method, is also a flame-propagation model that can efficiently track the positions of flame front 116 within volume 102 on a sub-grid level. Sub-grid level refers to processes that occur at length scales much smaller than a computational cell, and so cannot be adequately resolved by models running on the grid level. Other embodiments can, of course, use a different combustion model.

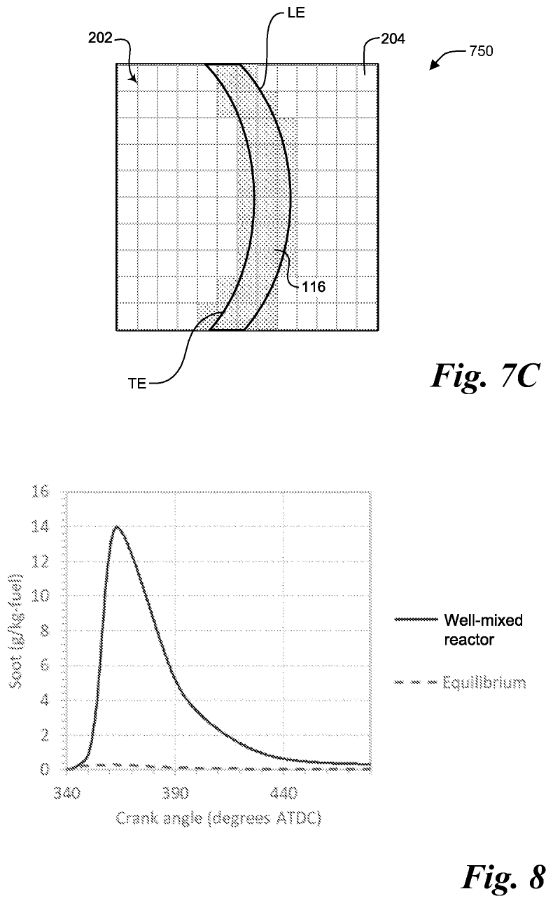

During a simulation, G-equation model 412 is used to track the location of the flame front, and both the G-equation model and the well-mixed-reactor are applied together in representative cells—i.e., cells that represent the flame front (see FIGS. 7A-7C)—to simulate chemical reaction within the flame front, which happen at a sub-grid level. This well-mixed reactor model em-ployed with the G-equation model is a sub-grid model. For computational cells outside the flame front where there is no need to resolve sub-grid processes i.e., computational cells other than the representative cells—the well-mixed-reactor model, which is a grid-level model, can be used alone, without the need for the G-equation model. Put differently, the well-mixed-reactor model is used with the G-equation model in the flame front, where processes must be resolved at sub-grid level, but is used without the G-equation model outside the flame front where no special treatment is needed because processes can be resolved at grid level.

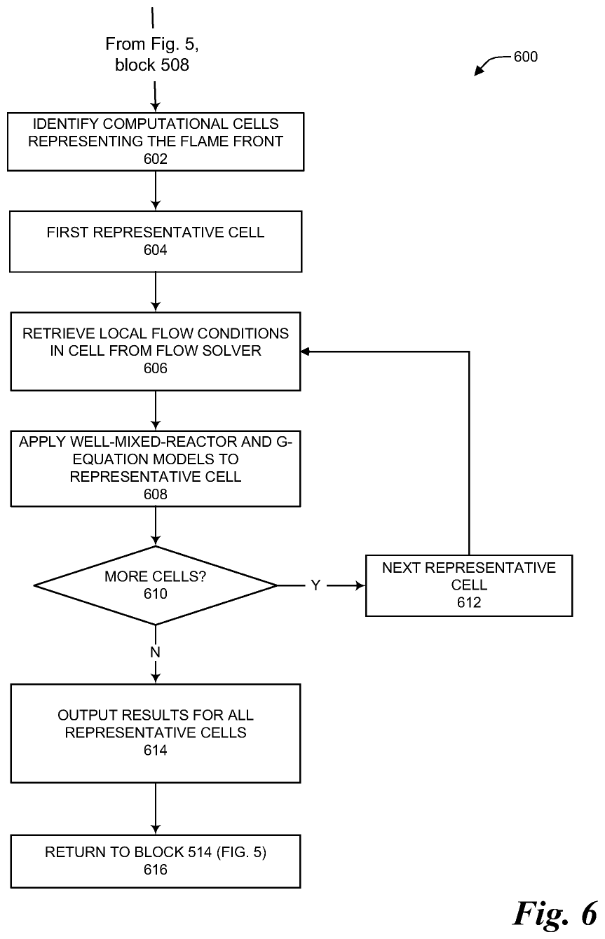

FIG. 5 illustrates an embodiment of a process 500 for computation of fluid flow characteristics and chemical results from propagation of a flame through volume 102, as shown in FIGS. 1A-IC. Process 500 uses a CFD code such as CFD code 400 (see FIG. 4) on a computational grid such as grid 202 (see FIGS. 2-3). In the illustrated embodiment of process 500 some parts of the process can operate at the grid-level while others operate at a sub-grid level, as indicated by the dashed boxes in the figure. But in other embodiments of process 500 the functions can be apportioned differently between grid-level and sub-grid level operation.

The process starts at block 502. At block 504, the process cre-ates computational grid 202 for volume 102 using grid generator 402, and at block 506 the process uses its spark-ignition model to compute the initiation of flame front 116 (see FIG. 1A). After the flame front is initiated at block 506, at block 508 the process tracks the flame front—that is, it tracks the positions of the leading edge LE and trailing edge TE of the flame front on the computational grid, using the G-equation combustion model to do so in one embodiment. In one embodiment flame front 116 need not be resolved by the flow solver or the combustion model, but can instead be tracked on a sub-grid level. Sub-grid tracking allows flame front 116 to be tracked on a coarse computational grid, thus requiring less computational resources. But in embodiments with a fine enough computational grid 202, flame front 116 can be resolved by the flow solver and combustion model.

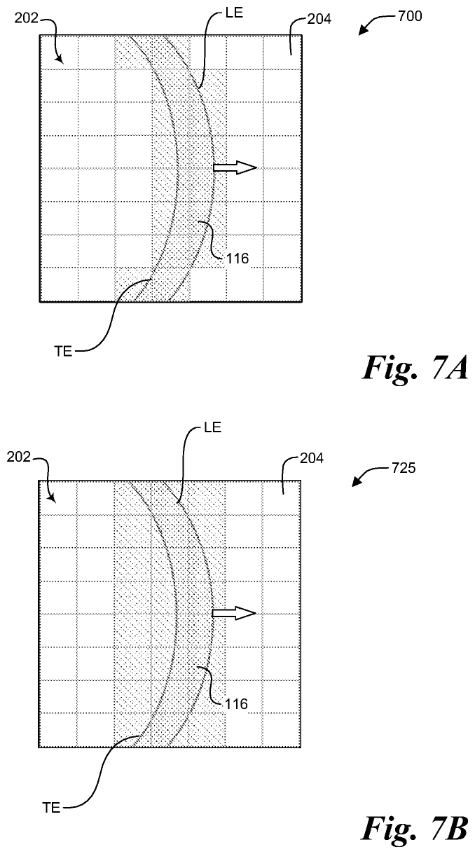

Having identified the location of flame front 116 in the computational grid at block 508, at block 510 the process applies the well-mixed-reactor and G-equation models cell-by-cell to representative computational cells—i.e., a group of cells that can be used as a representation of flame front 116. Application of both the well-mixed-reactor and G-equation models to the representative cells is discussed in more detail below in connection with FIG. 6, and embodiments of representative cells are discussed in more detail below in connection with FIGS. 7A-7C. Having applied the G-equation and well-mixed-reactor model at block 510, the process moves to block 512. At block 512, by applying the G-equation and well-mixed-reactor model at block 510 the process considers the impact of non-equilibrium time scales and dynami-cally defined residence time of chemical species based on local flame conditions. Put differently, the combination of G-equation and well-mixed-reactor models accounts for non-equilibrium effects in the chemical reactions happening within sub-grid features like the flame front during combustion, while also accounting for how long the different chemicals present in the flow spend in the flame front during combustion.

After applying the G-equation and well-mixed-reactor models at block 510, thereby accounting for non-equilibrium conditions and residence time at block 512, the process moves to block 514, where it solves for the steady-state of combustion in the flame front. The process then moves to block 516, where it tracks the chemical kinetics in end gas 110 (see FIGS. 1B-1C) and moves to block 518, where the process ends.

FIG. 6 illustrates an embodiment of a process 600 that, as indicated in block 510 of FIG. 5, applies a well-mixed-reactor model cell-by-cell to all the individual representative cells in computational grid 202. Representative cells are discussed below in connection with FIGS. 7A-7C).

Process 600 starts at block 602, where, based on flame-tracking information from the G-equation combustion model, it identifies representative computational cells 204—that is, a group of computational cells that can be used as a representation of flame front 116. The representative computational cells 204 can be different in different embodiments, but generally the representative cells will be a group of multiple individual computational cells that are associated with flame front 116, for instance by being fully inside the flame front, having at least part of the flame front in them (i.e., cells that are intersected by the leading edge LE, trailing edge TE, or both, of the flame front), being just ahead of the flame front, or being just behind the flame front. Embodiments of representative computational cells are illustrated in FIGS. 7A-7B.

Having identified representative computational cells at block 602, the process moves to block 604, where it starts with the first individual representative cell, then proceeds to block 606 where it retrieves local flow conditions in that cell from the flow solver. At block 608, the process applies well-mixed-reactor model and G-equation models (see FIG. 4) to the cell.

At block 610 the process checks whether any more representative cells remain to be processed. If at block 610 there are more representative cells to process, the process moves to block 612, selects the new representative cell, and returns to block 606. But if it block 610 there are no more individual representative cells left to process (i.e., all representative cells have been processed), the process moves to block 614, where it outputs the results in all the representative cells. At block 616 the process returns control to block 514 of FIG. 5.

FIGS. 7A-7C illustrate embodiments of representative computational cells—i.e., computational cells that can be used as a representation of flame front 116 during application of the well-mixed-reactor model and G-equation model, as shown in FIG. 6, because all or part of the flame front, or its computational representation, is within them.

FIG. 7A illustrates an embodiment of representative computation cells 700, which form the group of individual cells 204 shown shaded in the figure. Representative cells 700 are a group of cells that, for computational purposes, can be considered a representation of the flame front. In the illustrated embodiment representative cells are any computational cells 204 that have any part of flame front 116 within them. Put differently, every individual cell 204 of representative cells 700 is intersected by the flame front's leading edge LE, trailing edge TE, or both.

FIG. 7B illustrates another embodiment of representative computation cells 725, which form the group of individual cells 204 shown shaded in the figure. Representative cells 725 are formed of multiple columns of individual cells, including at least one column just ahead of, but not intersected by, the leading edge LE of the flame front and at least one column just behind, but not intersected by, the trailing edge TE of the flame front, so that the flame front is fully encompassed by representative cells 725. In the illustrated embodiment representative cells 725 include all of representative cells 700, but with cells added ahead of and behind flame front 116 so that the flame front is encompassed by three full columns of cells. Other embodiments can, of course, use a greater or lesser number of columns. This arrangement can be more efficient, since it can take less computational effort to identify the representative cells.

FIG. 7C illustrates another embodiment of representative computation cells 750, which form the group of individual cells 204 shown shaded in the figure. In some embodiments flame front 116 can be thick enough, and grid 202 fine enough (i.e., individual cells 204 can be small enough), that some individual cells 204 can be entirely within flame front 116. In these embodiments, representative cells 750 include all individual cells that are completely within the flame front, as well as all cells that are intersected by leading edge LE or trailing edge TE, or both, even if not completely within the flame front. In another embodiment, representative cells 750 can be supplemented by addi-tional cells ahead of and behind flame front 116, analogously to representative computation cells 725.

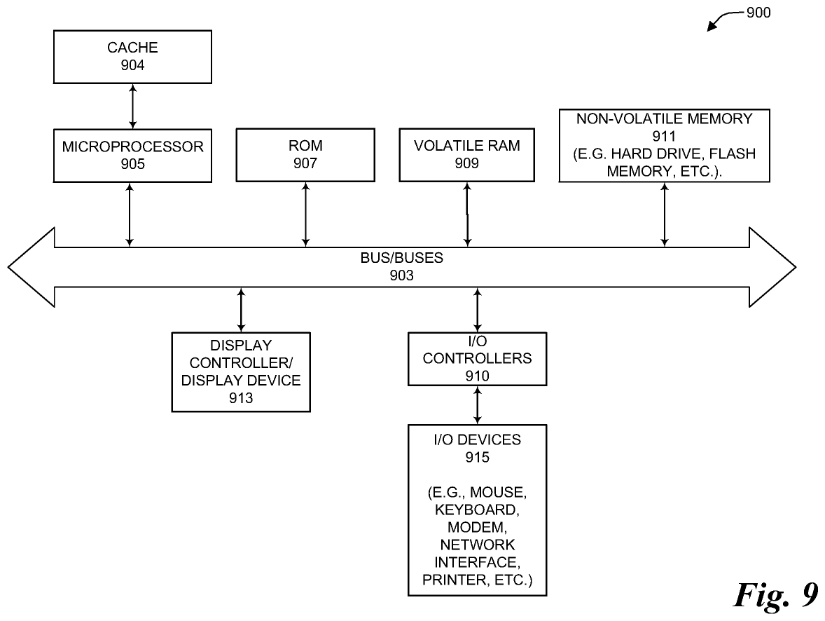

FIG. 8 illustrates the result of using a well-mixed-reactor model as described above to compute combustion in flame front 116. The figure applies to the cylinder of an internal combustion engine and is a graph that shows the relationship between the amount of soot and the engine's crank angle in degrees above top dead center (ATDC). The graph displays the result of computations using the equilibrium assumption and computations using the well-mixed-reactor model, as described above. It can be seen that the equilibrium assumption substantially underestimates the amount of soot compared to using the well-mixed-reactor model.

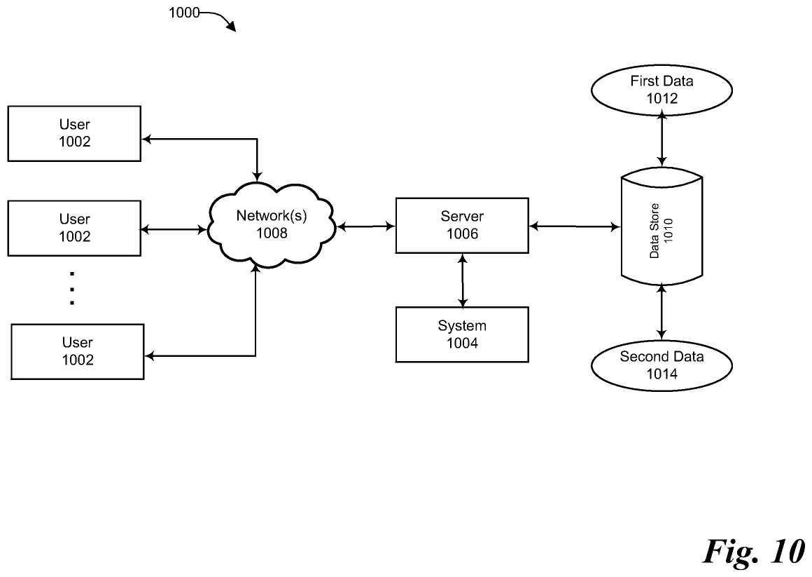

FIG. 9 illustrates an embodiment of a data processing system 900. System 900 can be used to perform any of the methods described abovee .g., the grid generator, the flow solver, any models or sub-models of the flow solver, etc. Thus, system 900 is an example of a simulation system that can execute the methods described herein. Although FIG. 9 illustrates the components of a data processing device, it is not intended to represent any particular architecture or way of interconnecting the components, because such details are not germane to the disclosure. It will also be appreciated that network computers and other data processing systems or other consumer electronic devices, which have fewer components or perhaps more components, can also be used with the disclosed embodiments.

System 900 is a data processing system that includes a bus 903 coupled to a microprocessor(s) 905, a ROM (Read Only Memory) 907, volatile RAM 909, and a non-volatile memory 911. Microprocessor(s) 905 can retrieve instructions from memories 907, 909, and 911 and execute the instructions to perform operations described above. Microprocessor(s) 905 can contain one or more processing cores. Bus 903 interconnects these various components together and also interconnects components 905, 907, 909, and 911 to a display controller and display device 913 and to peripheral devices such as input/output (I/O) devices 915 which can be touchscreens, mice, keyboards, modems, network interfaces, printers and other devices known in the art. Typically, in-put/output devices 915 are coupled to the system through input/output controllers 910.

Volatile RAM (Random Access Memory) 909 is typically implemented as dynamic RAM (DRAM), which requires continual power to re-fresh or maintain the data in the memory. Non-volatile memory 911 is typically a magnetic hard drive, a magnetic optical drive, an optical drive, a DVD RAM, a flash memory, or other types of memory systems that maintain data (e.g., large amounts of data) even after power is removed from the system. Typically, non-volatile memory 911 will also be a random-access memory, but this is not required. Although FIG. 9 shows that non-volatile memory 911 is a local device coupled directly to the rest of the components in the data processing system, other embodiments can utilize a non-volatile memory which is remote from the system, such as a network storage device which is coupled to the data processing system through a network interface such as a modem, an Ethernet interface, or a wireless network. Bus 903 can include one or more buses connected to each other through various bridges, controllers, and/or adapters as is well known in the art.

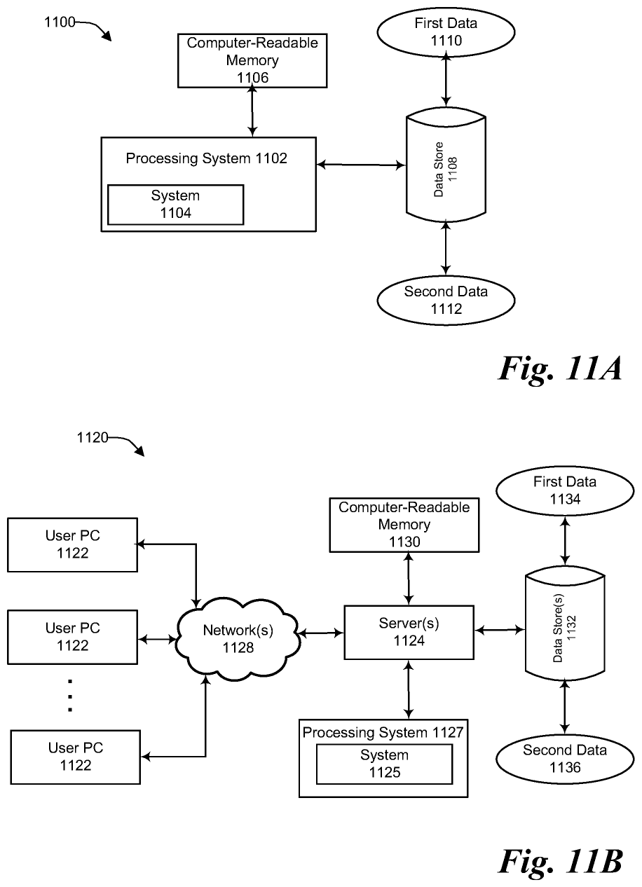

FIG. 10 illustrates a computer-implemented environment 1000 in which users 1002 can interact with a system 1004 hosted on one or more servers 1006 through a network 1008. System 1004 contains software operations or routines. Users 1002 can interact with system 1004 in a number of ways, such as over one or more networks 1008. One or more servers 1006 accessible through network(s) 1008 can host system 1004. It should be under-stood that system 1004 could also be provided on a stand-alone computer for access by a user.

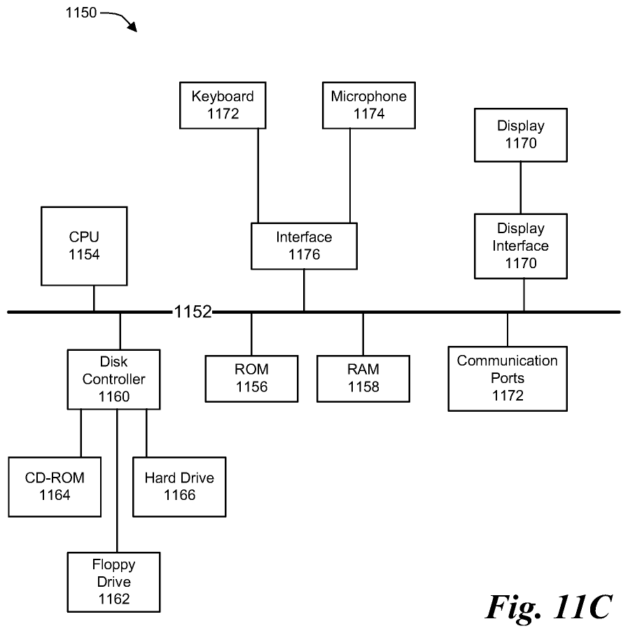

FIGS. 11A-11C illustrate embodiments of systems for implementing the methods described above. FIG. 11A illustrates an embodiment of a system 1100 that includes a standalone computer architecture where a processing system 1102 (e.g., one or more computer processors located in a given computer or in multiple computers that can be separate and distinct from one another) includes a system 1104 (e.g., CFD code 400) being executed on it. Processing system 1102 has access to a non-transitory computer-readable memory 1106 in addition to one or more data stores 1108. The one or more data stores 1108 can contain first data 210 (e.g., computational grid) as well as second data 212 (e.g., flow solver). Processing system 1102 can be a distributed parallel computing environment, which can be used to handle very large-scale data sets.

FIG. 11B illustrates an embodiment of a system 1120 that includes a client-server architecture. One or more user PCs 1122 accesses one or more servers 1124 running a system 1125 (e.g., CFD code 400) on a processing system 1127 via one or more networks 1128. The one or more servers 1124 can access a non-transitory computer readable memory 1130 as well as one or more data stores 1132. The one or more data stores 1132 can contain first data 234 (e.g., computational grid) as well as second data 236 (e.g., flow solver).

FIG. 11C illustrates an embodiment of hardware for a standalone computer architecture 1150, such as the architecture of FIG. 11A, that can be used to contain and/or implement the disclosed methods. A bus 1152 can serve as the information highway interconnecting the other illustrated components of the hardware. A processing system 1154 labeled CPU (central processing unit) (e.g., one or more computer processors), can perform calcula-tions and logic operations required to execute a program. A non-transitory com-puter-readable storage medium, such as read only memory (ROM) 1156 and random access memory (RAM) 1158, can be in communication with the processing system 1154 and can contain one or more programming instructions. Optionally, program instructions can be stored on a non-transitory computer-readable storage medium such as a magnetic disk, optical disk, recordable memory device, flash memory, or other physical storage medium. Computer instructions can also be communicated via a communications signal, or a mod-ulated carrier wave, e.g., such that the instructions can then be stored on a non-transitory computer-readable storage medium.

A disk controller 1160 interfaces one or more optional disk drives to system bus 1152. These disk drives can be external or internal floppy disk drives 1162, external or internal CD-ROM, CD-R, CD-RW or DVD drives 1164, or external or internal hard drives 1166. As indicated previously, these various disk drives and disk controllers are optional devices. Each of the ele-ment managers, real-time data buffer, conveyors, file input processor, database index shared access memory loader, reference data buffer, and data managers can include a software application stored in one or more of the disk drives con-nected to the disk controller 1160, the ROM 1156 and/or the RAM 1158. Pref-erably, the processor 1154 can access each component as required.

A display interface 1168 can permit information from the bus 1156 to be displayed on a display 1170 in audio, graphic, or alphanumeric for-mat. Communication with external devices can optionally occur using various communication ports 1172. In addition to the standard computer-type components, the hardware can also include data input devices, such as a keyboard 1172, or other input device 1174, such as a microphone, remote control, pointer, mouse, touchscreen and/or joystick.

Portions of what is described above may be implemented with logic circuitry such as a dedicated logic circuit or with a microcontroller or other form of processing core that executes program code instructions. Thus processes described above can be performed with program code such as ma-chine-executable instructions that cause a machine that executes these instructions to perform certain functions. In this context, a “machine” may be a ma-chine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or electronic circuitry disposed on a semiconductor chip (e.g., “logic circuitry” implemented with transistors) designed to execute instructions such as a general-purpose processor and/or a special-purpose processor. Processes taught by the discus-sion above may also be performed by (in the alternative to a machine or in combination with a machine) electronic circuitry designed to perform the processes (or a portion thereof) without the execution of program code.

The disclosure also relates to an apparatus for performing the operations described herein. This apparatus may be specially constructed for the required purpose, or it may comprise a general-purpose device selectively activated or reconfigured by a computer program stored in the device. Such a computer program may be stored in a non-transitory computer readable storage medium, such as, but not limited to, any type of disk including floppy disks, optical disks, CD-ROMs, and magnetic-optical disks, DRAM (volatile), flash memory, read-only memories (ROMs), RAMs, EPROMS, EEPROMs, magnetic or optical cards, or any type of media suitable for storing electronic instructions, and each coupled to a device bus.

A machine-readable medium includes any mechanism for storing information in a form readable by a machine (e.g., a computer or any of its components such as a microprocessor). For example, a non-transitory machine-readable medium includes read only memory (“ROM”); random access memory (“RAM”); magnetic disk storage media; optical storage media; flash memory devices; etc.

An article of manufacture can be used to store program code. An article of manufacture that stores program code may be embodied as, but is not limited to, one or more non-transitory memories (e.g., one or more flash memories, random access memories (static, dynamic, or other)), optical disks,

CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)) and then stored in non-transitory memory (e.g., DRAM or flash memory or both) in the client computer.

The above description of embodiments is not intended to be exhaustive or to limit the invention to the described forms. Specific embodiments of, and examples for, the invention are described herein for illustrative purposes, but various modifications are possible that yield embodiments not described above that are nonetheless within the scope of the invention.

What is claimed is:

1. A non-transitory machine-readable medium storing executable instructions which when executed by a data processing system cause the data processing system to:
establish a computational grid that represents a volume containing a combustible fluid mixture, the computational grid including a plurality of computational cells;
identify positions in the computational grid of a flame front propagating through the combustible fluid mixture;
identify, using a flame propagation model, a set of representative computational cells that contain a computational representation of the flame front; and
apply a sub-grid well-mixed-reactor model to the flame-front volume inside every computational cell within the set of representative computational cells to compute chemical results from combustion of the fluid mixture in the flame front.

2. The non-transitory machine-readable medium of claim 1 wherein the executable instructions further include instructions to compute fluid dynamic characteristics within the volume using a flow solver.

3. The non-transitory machine-readable medium of claim 2 wherein the well-mixed reactor model is integrated with the flow solver.

4. The non-transitory machine-readable medium of claim 3 wherein the G-equation model is integrated with the well-mixed reactor model.

5. The non-transitory machine-readable medium of claim 3 the positions of the flame front in the computational grid are identified using the G-equation model.

6. The non-transitory machine-readable medium of claim 1 wherein the representative computational cells are a set of computational cells all of which have any part of the flame front within them.

7. The non-transitory machine-readable medium of claim 6 wherein the computational cells that have any part of the flame front within them include computational cells that are intersected by a leading edge of the flame front, a trailing edge of the flame front, or both the leading and trailing edges of the flame front.

8. The non-transitory machine-readable medium of claim 7 wherein the representative computational cells further include computational cells ahead of and not intersected by the leading edge of the flame front, computational cells behind and not intersected by the trailing edge of the flame front, or both.

9. The non-transitory machine-readable medium of claim 7 wherein the computational cells that have any part of the flame front within them include computational cells that are entirely within the flame front.

10. A computer-implemented method comprising:
establishing a computational grid that represents a volume containing a combustible fluid mixture, the computational grid including a plurality of computational cells;
identifying positions in the computational grid of a flame front propagating through the combustible fluid mixture;
identifying, using a flame propagation model, a set of representative computational cells that contain a computational representation of the flame front; and
applying a sub-grid well-mixed-reactor model to the flame-front volume inside every computational cell within the set of representative computational cells to compute chemical results from combustion of the combustible fluid mixture in the flame front.

11. The computer-implemented method of claim 10, further comprising computing fluid dynamic characteristics within the volume using a flow solver.

12. The computer-implemented method of claim 11 wherein well-mixed-reactor model is integrated with the flow solver.

13. The computer-implemented method of claim 12 wherein the G-equation model is integrated with the well-mixed-reactor model.

14. The computer-implemented method of claim 12 wherein the positions of the flame front in the computational grid are identified using the G-equation model.

15. The computer-implemented method of claim 10 wherein the representative computational cells are a set of computational cells all of which have any part of the flame front within them.

16. The computer-implemented method of claim 15 wherein the computational cells that have any part of the flame front within them include computational cells that are intersected by a leading edge of the flame front, a trailing edge of the flame front, or both the leading and trailing edges of the flame front.

17. The computer-implemented method of claim 16 wherein the representative computational cells further include computational cells ahead of and not intersected by the leading edge of the flame front, computational cells behind and not intersected by the trailing edge of the flame front, or both.

18. The computer-implemented method of claim 16 wherein the computational cells that have any part of the flame front within them include computational cells that are entirely within the flame front.
